(19) United States
(12) Patent Application Publication
(10) Pub. No.: US 2009/0025686 A1
(43) Pub. Date: Jan. 29, 2009

(54) FUEL INJECTION SYSTEM FOR INTERNAL COMBUSTION ENGINE

(76) Inventors: Hiroaki Kato, Saitama (JP); Takao Iwasaki, Saitama (JP); Teruo Ohsawa, Saitama (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/278,441

(22) PCT Filed: Jun. 19, 2006
(86) PCT No.: PCT/JP2006/312223

§ 371 Date: Aug. 6, 2008

(30) Foreign Application Priority Data
Feb. 24, 2006 (JP) 2006-047788

(51) Int. Cl. F02M 69/46

(52) U.S. Cl. 123/456; 123/457

(57) ABSTRACT

To provide a fuel injection system that can efficiently supply high pressure fuel with respect to fuel injectors of an internal combustion engine, whose pump is capable of being made versatile, and which has excellent maintainability such as service, replacement and detachment.

An internal combustion engine fuel injection system comprises: one cassette type pump that is detachably attached to an internal combustion engine disposed with a cam and pressurizes fuel to a high pressure and pressure-feeds fuel in accompaniment with rotation of the cam; and a common rail that accumulates high pressure fuel that is pressure-fed from the one cassette type pump and supplies the high pressure fuel with respect to plural fuel injectors, wherein the cam is fixed to a camshaft and the camshaft is connected in a predetermined gear ratio with respect to a crankshaft of the internal combustion engine, and the one cassette type pump is disposed with just one plunger for pressurizing fuel in accompaniment with rotation of the cam and just one discharge valve for discharging fuel that has been pressurized by the plunger.

### TECHNICAL FIELD

The present invention relates to an internal combustion engine fuel injection system and to an internal combustion engine fuel injection system that is used mainly in industrial engines of agricultural machinery, construction machinery, and marine vessels.

### BACKGROUND ART

Conventionally, in industrial engines used in agricultural machinery and construction machinery, a fuel injection system disposed with a cassette type pump and fuel injection valves has been used as a fuel injection system that injects fuel from fuel injectors of a diesel engine. This fuel injection system pressure-feeds fuel that has been pressurized to a high pressure by the cassette type pump that is attached to the engine and injects the pressure-fed fuel into cylinders of the internal combustion engine by the fuel injection valves.

In this fuel injection system, valves of a check valve structure that are opened when the pressure of the fuel exceeds a predetermined value and closed when the pressure of the fuel falls below a predetermined value are used as the fuel injection nozzles, and the injection amount and the injection timing of the fuel are controlled mainly by the cassette type pump.

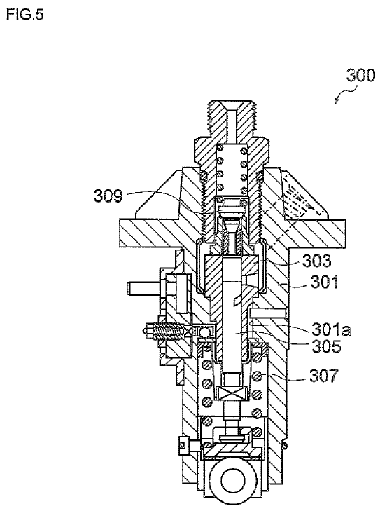

As such a cassette type pump, as shown in FIG. 5, there is a pump 300 that is detachably attached to a diesel engine disposed with a cam, and the pump 300 is disposed with a circular cylinder-shaped barrel 303 that is held inside a housing 301, a plunger 305 that is disposed such that it may freely reciprocally move inside the barrel 303 and is for pressurizing fuel in response to rotation of the cam, a spring 307 that energizes the plunger 305 in an opposite direction of a direction in which the plunger 305 pressurizes the fuel, and a discharge valve 309 for discharging the fuel that has been pressurized by the plunger 305 (e.g., see Patent Document 1).

In this cassette type pump, fuel is fed into a fuel pressurization chamber via a fuel passage disposed in the housing in a state where the plunger is lowered, the plunger rises in accompaniment with rotation of the cam that is disposed in the engine, a suction port is closed, and the fuel inside the fuel pressurization chamber is pressurized to a high pressure. Then, when the fuel exceeds a predetermined pressure, the fuel is pressure-fed to corresponding fuel injectors via the discharge valve.

In this cassette type pump, control of the flow rate of the fuel that is pressure-fed is performed using a lead that is disposed in the plunger and comprises a groove that is formed in a diagonal direction with respect to the axial direction and a rack mechanism for causing the plunger to rotate about its axis. Specifically, because the lead is disposed in the plunger, when the plunger rises to a predetermined position, the fuel pressurization chamber and the fuel passage become communicated, the fuel inside the fuel pressurization chamber is spilled into the fuel passage via the lead, and the flow rate of the fuel that is pressure-fed is prescribed. Further, because the lead is disposed in a diagonal direction with respect to the axial direction of the plunger, the capacity inside the fuel pressurization chamber at a point in time when the fuel inside the fuel pressurization chamber is returned is prescribed by the rotational position of the plunger, and the flow rate of the fuel that is discharged is controlled to a desired value. The rotational position of the plunger is determined by controlling the rack mechanism by a governor mechanism or the like that is connected to the engine.

Further, in this cassette type pump, control of the injection timing of the fuel is performed by, for example, disposing a timer, causing the camshaft to advance, and adjusting the timing of the rise of the plunger.

Further, in a fuel injection system disposed with a conventional cassette type pump, a number of pumps (number of plungers) that corresponds to the number of cylinders of the engine is employed. Additionally, in the case of an engine that rotates two times during one cycle from intake to exhaust, the gear ratio that prescribes the number of rotations of the pump with respect to the number of rotations of the engine is set to 1/2, and main injection is set to be performed one time each inside each of the cylinders of the engine in one cycle. In this conventional configuration, pumps of a plural number are used, one or pumps of a plural number are plurally used, and the plunger diameter and the stroke amount of the plunger are appropriately selected and designed in response to the required output of the engine.

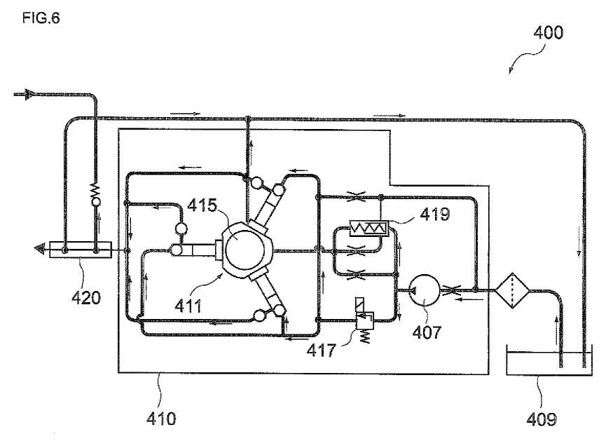

On the other hand, as engine fuel injection systems used for automobiles and large vehicles, various types of pressure accumulating fuel injection systems (sometimes called “common rail systems” below) that use a pressure accumulator (common rail) have been proposed. This pressure accumulating fuel injection system is, as shown in FIG. 6, disposed with a fuel supply pump 410 that is disposed with a pump body 411, a feed pump 407 and a regulating valve 419, with a cam 415 being disposed in the pump 410 itself, a pressure accumulator 420 that accumulates high pressure fuel that is pressure-fed from the fuel supply pump 410 and pressure-feeds the high pressure fuel with respect to plural injectors, and injectors (not shown) that inject, with respect to cylinders of an internal combustion engine, the fuel that is pressure-fed.

In this pressure accumulating fuel injection system 400, control of the injection amount of the fuel is performed by electromagnetically controlling the opening degree of the regulating valve of the fuel supply pump 410 and valves in the injectors. Further, control of the injection timing of the fuel is performed by electromagnetically controlling the timing when the valves in the injectors are opened.

This pressure accumulating fuel injection system can raise the pressure of the fuel to a higher pressure and can precisely control the injection amount and the injection timing of the fuel, so it can easily realize control of the operating state of the engine and purification of exhaust gas that is discharged.

### Patent Document 1: JP-B-7-117017 (FIG. 6)

### DISCLOSURE OF THE INVENTION

### Problem that the Invention is to Solve

However, the fuel injection system that uses a cassette type pump described in Patent Document 1 performs control of the injection amount and the injection timing by the mechanical configuration of the cassette type pump, and the structures of the respective members become complex and high-precision design of the pump and the cam has been required in order to precisely perform control.

Further, in order to respond to the request for even higher pressurization of fuel in recent years, it has been necessary to enlarge the diameter and the stroke amount of the plunger or to improve the shape of cam crests on the side of the engine. Moreover, in a conventional cassette type pump, it has been necessary to take measures to prevent wear and damage resulting from high pressure fuel being spilled, and it has been necessary to make the structures of members even more complex in order to respond to even higher pressurization. On the other hand, when the configurations of those members are made complex, there has been the potential for their strength to drop and a limit to be seen on high pressurization of fuel and for their durability to drop.

Further, in a conventional cassette type pump, plural types of pumps where the cylinder number (number of plungers), the plunger diameters and the stroke amount of the plungers are different have been prepared, and the pumps that are used have been diversified in correspondence to engine output and the number of cylinders. Further, as a result of this, the parts that are used also become different, so this has been a factor that does not allow production costs to be lowered. Moreover, in the case of a pump disposed with plural plungers, there is also a limit on making the pump compact, so there has also been the problem that the installation space in the internal combustion engine becomes larger and it is difficult to make the internal combustion engine compact.

On the other hand, the pressure accumulating fuel injection system shown in FIG. 6 is capable of more precise control of the injection timing and the injection amount because of the regulating valve and the injectors, but the pump that is used is a relatively large pump disposed with the feed pump, the pump body and the regulating valve. Consequently, there has been the problem that, in the field of industrial engines, layout and design during installation are difficult in comparison to a cassette type pump, and maintenance such as service, replacement and detachment takes effort.

Moreover, in the case of the pressure accumulating fuel injection system shown in FIG. 6, the pump is uniquely disposed with the cam, and it has been necessary to circulate engine fuel or to separately introduce lubricating oil as lubricating oil that suffuses the sliding surfaces between the plunger and the plunger barrel and the sliding surfaces between the cam and the tappet. Consequently, when engine fuel is used, high lubricity is demanded of that engine fuel, and when fuel cleanliness is low, there has been the potential for the lubricity to drop. On the other hand, when lubricating oil is separately introduced, management of the lubricating oil becomes necessary in addition to the engine fuel and the engine oil, which is inefficient in the field of industrial engines where a configuration that is as simple as possible and high durability are desired.

Thus, as a result of their extensive investigations, the inventors of the present invention have discovered that this problem can be solved by employing one cassette type pump in a pressure accumulating fuel injection system disposed with a common rail and by configuring the cassette type pump to be disposed with just one plunger.

That is, it is an object of the present invention to provide a fuel injection system whose production costs can be reduced by making its pump versatile and making its parts common, has excellent maintainability during service, replacement and detachment, and can be made compact overall.

### Means for Solving the Problem

According to the present invention, there is provided an internal combustion engine fuel injection system comprising: one cassette type pump that is detachably attached to an internal combustion engine disposed with a cam and pressurizes fuel to a high pressure and pressure-feeds fuel in accompaniment with rotation of the cam; and a common rail that accumulates high pressure fuel that is pressure-fed from the one cassette type pump and supplies the high pressure fuel with respect to plural fuel injectors, wherein the cam is fixed to a camshaft and the camshaft is connected in a predetermined gear ratio with respect to a crankshaft of the internal combustion engine, and the one cassette type pump is disposed with just one plunger for pressurizing fuel in accompaniment with rotation of the cam and just one discharge valve for discharging fuel that has been pressurized by the plunger. Thus, the aforementioned problem can be solved.

Further, in configuring the internal combustion engine fuel injection system of the present invention, it is preferred that the number of times that the high pressure fuel is pressure-fed from the cassette type pump when the internal combustion engine has rotated one cycle is made to match the number of cylinders of the internal combustion engine by a combination of the gear ratio and the number of cam crests of the cam.

Further, in configuring the internal combustion engine fuel injection system of the present invention, it is preferred that the fuel injection system further comprises a pressure regulator that regulates pressure inside the common rail and pressure control means that controls the pressure regulator on the basis of a pressure value inside the common rail.

Further, in configuring the internal combustion engine fuel injection system of the present invention, it is preferred that the fuel injectors are electromagnetic control valves.

Further, in configuring the internal combustion engine fuel injection system of the present invention, it is preferred that the fuel injection system is used in any of construction machinery, agricultural machinery, marine vessels and electrical generators.

### EFFECTS OF THE INVENTION

According to the fuel injection system of the present invention, by employing, in an internal combustion engine fuel injection system disposed with a cassette type pump, a common rail system disposed with a cassette type pump of a predetermined structure whose mechanical configuration has been abbreviated and a common rail, the fuel injection system can be made into a fuel injection system where the design and manufacture of the cassette type pump are made easy and whose entire system is simplified in comparison to a conventional common rail system. Consequently, the mechanical strength and durability of the fuel injection system can be improved even when the fuel injection system supplies higher pressure fuel in the field of industrial engines. Further, by configuring the fuel injection system in this manner, its entire system can be made compact even when compared to a conventional common rail system.

Further, by using just one cassette type pump disposed with one plunger, the pump can be made versatile regardless of the number of cylinders of the internal combustion engine, and the parts that configure the pump and the parts that are used in the internal combustion engine can be made common. Consequently, production costs can be lowered. Moreover, when the pump is a pump where the number of plungers is one, the pump can be made compact, the installation space in the internal combustion engine can be made small, and the entire internal combustion engine can be made compact.

Further, even when the system is configured to be disposed with just one plunger, synchronous injection, where fuel injection in the fuel injectors and pressure-feeding from the pump are synchronized, becomes possible by making the gear ratio between the crankshaft and the camshaft and the number of cam crests into a predetermined combination. Consequently, the operating state of the internal combustion engine can be stabilized, noise during operation can be reduced, and exhaust gas can be purified.

Further, by employing a cassette type pump as the pump of the common rail system, maintainability, such as service, replacement and detachment of the pump, can be improved. Further, because the internal combustion engine is disposed with a cam that causes the plunger of the pump to reciprocally move, effort to synchronize the cam with a gear or the like of the internal combustion engine when the pump is attached can be dispensed with, the work of attachment can be made more efficient, and the operating stability of the pump can be improved.

Moreover, by employing a cassette type pump as the pump of the common rail system, engine oil introduced to the inside of the internal combustion engine can be utilized as lubricating oil that suffuses the contact surfaces between the cam and the plunger, the cam and the spring seat, the cam and the tappet, and the sliding surface of the tappet, so lubricity can be ensured regardless of the cleanliness of the engine fuel that is used. Additionally, because the lubricity of the respective parts improves, the pump can be made into a pump that has excellent durability even when the pump supplies fuel of a pressure that is higher than has conventionally been the case.

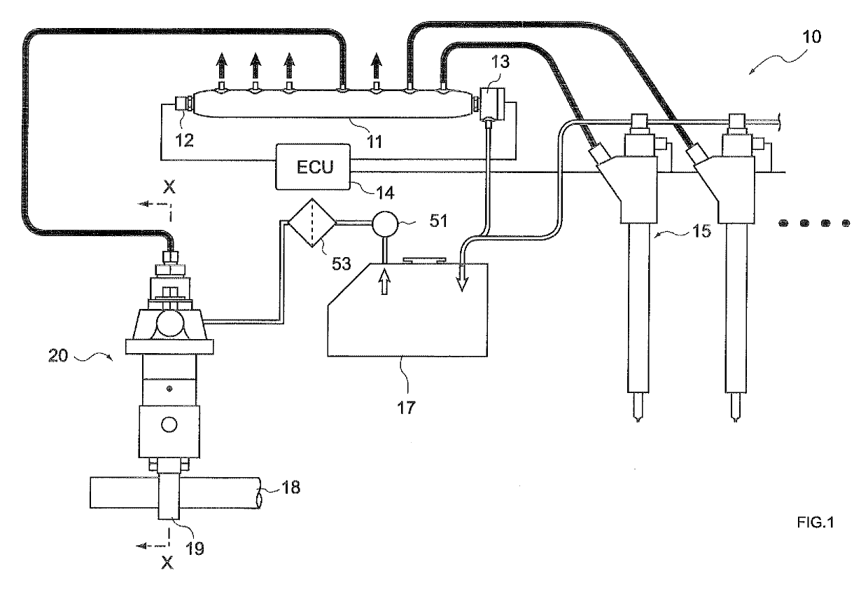

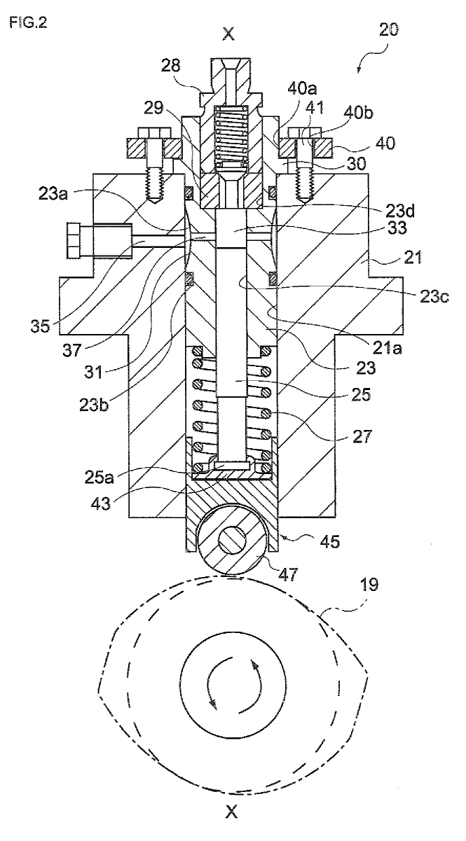

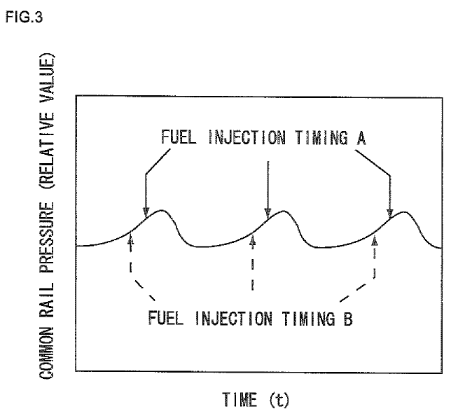

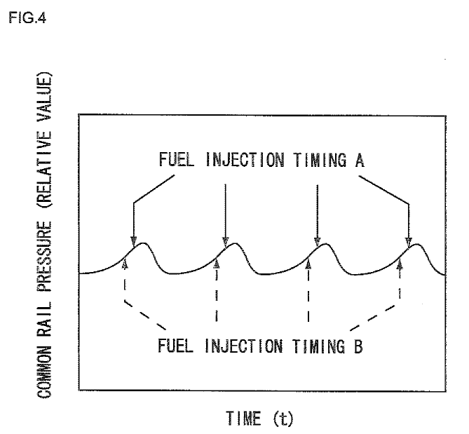

### BRIEF DESCRIPTION OF THE DRAWINGS

[FIG. 1] A diagram provided for describing the configuration of a fuel injection system of the present invention.

[FIG. 2] A cross-sectional diagram of a cassette type pump of the present invention.

[FIG. 3] A diagram provided for describing the relationship between common rail pressure and an injection period in a three-cylinder engine.

[FIG. 4] A diagram provided for describing the relationship between common rail pressure and an injection period in a four-cylinder engine.

[FIG. 5] A diagram provided for describing the configuration of a conventional cassette type pump.

[FIG. 6] A diagram provided for describing the configuration of a conventional common rail system.

### BEST MODE FOR IMPLEMENTING THE INVENTION

Below, an embodiment relating to an internal combustion engine fuel injection system of the present invention will be specifically described with reference to the drawings. However, this embodiment represents one aspect of the present invention, is not intended to limit this invention, and is capable of being arbitrarily altered within the scope of the present invention.

The embodiment of the present invention is an internal combustion engine fuel injection system comprising: one cassette type pump that is detachably attached to an internal combustion engine disposed with a cam and pressurizes fuel to a high pressure and pressure-feeds fuel in accompaniment with rotation of the cam; and a common rail that accumulates high pressure fuel that is pressure-fed from the one cassette type pump and supplies the high pressure fuel with respect to plural fuel injectors, wherein the cam is fixed to a camshaft and the camshaft is connected in a predetermined gear ratio with respect to a crankshaft of the internal combustion engine, and the one cassette type pump is disposed with just one plunger for pressurizing fuel in accompaniment with rotation of the cam and just one discharge valve for discharging fuel that has been pressurized by the plunger.

Below, the internal combustion engine fuel injection system will be divided into its respective parts and specifically described.

### 1. Overall Configuration of Fuel Injection System

First, the overall configuration of a fuel injection system of the present embodiment will be described with reference to FIG. 1. This fuel injection system 10 is a system for supplying fuel to fuel injectors (sometimes called “injectors”) 15 disposed in an internal combustion engine such as a diesel engine and causing the fuel injectors 15 to inject the fuel, and the fuel injection system 10 is basically configured to include: a cassette type pump (sometimes simply called a “pump” below) 20 that is detachably attached to an internal combustion engine (not shown) disposed with a cam 19; and a common rail 11 serving as a pressure accumulator.

Further, it is preferred that the fuel injection system pertaining to the present invention is used mainly in compact industrial engines of construction machinery, agricultural machinery, small marine vessels and electrical generators. This is because, in engines used in the aforementioned industrial fields, oftentimes inferior fuel and low lubricity fuel are used as the engine fuel for reasons such as use environment and low cost, so when a fuel lubrication system is employed, it is easy to cause parts wear. That is, by employing a cassette type pump that is attached to an internal combustion engine as in the present invention, engine oil whose lubricity is high can be used as lubricating oil, and the durability of the pump can be improved.

### 2. Internal Combustion Engine

The internal combustion engine is disposed with a camshaft 18 that is connected in a predetermined gear ratio with respect to a crankshaft (not shown). Further, one cam 19, for causing one plunger disposed in the cassette type pump 20 that is attached to reciprocally move, is disposed on the camshaft 18. Moreover, although it is not shown, an opening that becomes an attachment place of the cassette type pump 20 is disposed in a housing of the internal combustion engine in correspondence to the position of the cam 19. For example, as mentioned later, when the outer shape of a housing of the cassette type pump is perfectly circular, the opening is also substantially perfectly circular.

Further, because the fuel injection system 10 of the present invention has a configuration where the cam 19 is disposed in the internal combustion engine and not in the pump 20, the selection range of the base diameter of the cam broadens in comparison to a conventional cam that is disposed in a pump, and the cam design can be done easily. Further, because the base diameter of the cam can be enlarged, stress that acts when the pump is driven can be alleviated. Further, in the fuel injection system of the present invention, as mentioned later, just the function of pressurizing fuel to a high pressure and pressure-feeding fuel is demanded of the cassette type pump, so the complex design of the cam crest such as has been employed in a conventional cassette type pump can be abbreviated. Consequently, even when the cam is rotated at a high speed in order to increase the fuel flow rate, the durability of the cam improves and its reliability can be improved.

Moreover, because the cam is disposed in the internal combustion engine, effort to synchronize the cam with a gear or the like of the internal combustion engine when the pump is attached can be dispensed with, the work of attachment can be made more efficient, and the operating stability of the pump can be improved.

### 3. Cassette Type Pump

### (1) Basic Configuration

The cassette type pump 20 is a part for pressurizing fuel to a high pressure and pressure-feeding fuel to the common rail 11. FIG. 2 shows an example of the configuration of the cassette type pump 20 that is used in the fuel injection system 10 of the present embodiment.

FIG. 2 is a cross-sectional diagram of an XX cross section of the cassette type pump 20 shown in FIG. 1 as seen in the direction of the arrows. The cassette type pump 20 is disposed with a housing 21 that includes a circular column space 21a whose both ends are open, a substantially circular cylinder-shaped barrel 23 that is inserted into the circular column space 21a in the housing 21, a plunger 25 that is held by the barrel 23 such that the plunger may freely reciprocally move and is for pressurizing fuel in response to rotation of the cam 19 that is disposed in the internal combustion engine, a spring 27 that energizes the plunger 25 in an opposite direction of a direction in which the plunger 25 pressurizes the fuel, and a discharge valve 29 for discharging fuel that has been pressurized by the plunger 25.

The discharge valve 29 is a so-called check valve type of valve that is opened when high pressure fuel inside a fuel pressurization chamber 33 that is pressurized by the plunger 25 exceeds a predetermined pressure value and is closed when the pressure inside the fuel pressurization chamber 33 falls below a predetermined value, and the discharge valve 29 is fixed as a result of being screwed by a holder 28 from above.

In this cassette type pump 20, in a state where the plunger 25 is pushed down by the energizing force of the spring 27, fuel that has been pressure-fed from a fuel tank flows, via a fuel passage 35 that is disposed in the housing 21, into a pressure introduction chamber 31 that is formed by the circular column space 21a in the housing 21 and a groove portion 23a in the outer peripheral surface of the barrel 23. Thereafter, the fuel flows into the fuel pressurization chamber 33 via a fuel passage 37 that is disposed in the barrel 23 and interconnects the pressure introduction chamber 31 and the fuel pressurization chamber 33.

Additionally, when the plunger 25 is pushed up in accompaniment with rotation of the cam 19 that is disposed in the internal combustion engine, the fuel passage 37 in the barrel 23 that had faced the fuel pressurization chamber 33 becomes closed by the plunger 25, and the fuel inside the fuel pressurization chamber 33 is pressurized to a high pressure. Thereafter, when the pressure of the fuel inside the fuel pressurization chamber 33 exceeds a predetermined threshold value, the discharge valve 29 is opened and the fuel is pressure-fed to the common rail.

In this manner, just the function of pressurizing fuel to a high pressure and continuously pressure-feeding fuel is demanded of the cassette type pump that is used in the fuel injection system of the present invention, and it becomes unnecessary to dispose a lead in the plunger and dispose a rack and governor mechanism for controlling the rotational position of the plunger in order to perform flow rate control and pressure regulation as in a conventional cassette type pump. Consequently, it becomes unnecessary to implement high pressure fuel spill measures and precisely control the stroke amount of the plunger and the injection timing.

Thus, the mechanical configuration of the respective members can be abbreviated and remarkably simplified, so their mechanical strength is improved, and wear and damage can be reduced even when the pump supplies higher pressure fuel. Further, because the configuration of the pump can be remarkably simplified, the parts of the pump can be made versatile without limit to the type and specification of the internal combustion engine, and economical design and production become possible.

Further, when the fuel injection system has a configuration disposed with one cassette type pump as in the present invention, it suffices for the installation space to be small in comparison to an independent pump such as used in a conventional common rail system, so the layout and design of the pump can be done relatively easy. Further, because the pump can be easily detached, maintenance work such as service, replacement and detachment of the pump can be performed efficiently.

Moreover, by employing a cassette type pump as the pump of the common rail system, engine oil introduced to the inside of the internal combustion engine can be utilized as lubricating oil that suffuses the contact surfaces between the cam and the plunger, the cam and the spring seat, the cam and the tappet, and the sliding surface of the tappet, so management and maintenance of the lubricating oil becomes easy in comparison to an independent pump used in a conventional common rail system. Further, conventionally, although there have also been instances where engine fuel is used as lubricating oil, by using engine oil as lubricating oil, lubricity can be ensured regardless of the cleanliness of the engine fuel. Additionally, lubricity of the respective parts improves, so the pump can be made into a pump that has excellent durability and whose reliability is high even when the pump supplies fuel of a pressure that is higher than has conventionally been the case.

### (2) Housing

The outer shape of the housing 21 of the cassette type pump shown in FIG. 2 is not particularly limited, but by unifying the outer shape of the housing 21 to a predetermined shape even when the diameter of the plunger is different and allowing the shape of the opening that is disposed in the internal combustion engine and serves as the attachment place of the pump 20 to correspond to the outer shape of the housing 21, an advantage is obtained in that pumps whose specifications are different can be freely selected and used in different types of internal combustion engines.

Further, the housing 21 includes the circular column space 21a, whose both ends are open and into which the barrel 23 is inserted. It is preferred that, in order to make workability when forming the circular column space 21a easier, the circular column space 21a is not disposed with a step or a groove in its inner peripheral surface.

### (3) Barrel

The barrel 23 is a substantially circular cylinder-shaped member that has an outer shape that conforms to the circular column space 21a in the housing 21. The outer peripheral surface of the barrel 23 is disposed with a first groove portion 23a that forms the pressure introduction chamber together with the inner peripheral surface of the housing 21 and plural seal ring groove portions 23b for preventing fuel leakage from between the outer peripheral surface of the barrel 23 and the inner peripheral surface of the housing 21. Further, the inner portion of the barrel 23 includes a small diameter space 23c that is an element into which the plunger 25 is inserted and which forms the fuel pressurization chamber 33 and a large diameter space 23d in which the discharge valve 29 is disposed. Additionally, the plunger 25 is inserted from below and slidably held in the small diameter space 23c, and the discharge valve 29 is inserted from above into the large diameter space 23d and fixed as a result of screwing the holder from above.

Here, the conventional cassette type pump shown in FIG. 5 has a configuration where the barrel that slidably holds the plunger inside is nipped by and held between the holder and the housing from the vertical direction at a place that is close to the small diameter space in which the plunger slides, so there is the potential for the barrel to receive stress that acts when the discharge valve is fixed and become deformed. When deformation of the barrel occurs, the small diameter space in which the plunger slides becomes deformed and inhibits the reciprocal motion of the plunger.

That is, a clearance is disposed between the barrel and the plunger in order to control wear at the sliding surfaces of those, and the clearance is filled with lubricating oil, but there are cases where the pressure of the fuel that is pressure-fed is a relatively low pressure as in a conventional small industrial engine, and in the fuel injection system of the present invention where a pressure value equal to or greater than 1.5 times in comparison to what has conventionally been the case is demanded, when the clearance between the plunger and the barrel is narrowed by deformation of the small diameter space in the barrel, the potential for the lubricating oil to become scarce and cause burning becomes higher. In particular, in the fuel injection system of the present invention, it is conceivable that the potential for damage to the barrel and the plunger becomes higher when stress generated in the pump becomes larger and the drive speed of the pump becomes faster.

Thus, the cassette type pump that is used in the fuel injection system of the present embodiment is disposed with a flange portion 30 on the outer peripheral surface of the barrel 23, and the flange portion 30 is nipped by and held between the housing 21 and a fixing plate 40, whereby the barrel 23 is fixed to the housing 21. Consequently, the upper side and the lower side of the barrel 23 are opened other than when stress acts on just the flange portion 30, so stress from the fixing plate 40 and stress when fixing the discharge valve 29 can be prevented from extending to the small diameter space 23c in which the plunger 25 reciprocally moves. Thus, the small diameter space 23c does not become deformed and the reciprocal motion of the plunger 25 is not inhibited, so the durability of the pump can be improved even when the cassette type pump is employed in a common rail system and pressure-feeds a large amount of high pressure fuel in accompaniment with high speed rotation of the cam 19. For that reason, in the fuel injection system of the present invention, stress acting on the barrel is reduced as much as possible and deformation of the small diameter space is prevented

### (4) Fixing Plate

The fixing plate 40 shown in FIG. 2 is a member for fixing the barrel 23 with respect to the housing 21 as a result of the Fixing plate 40 being screwed with respect to the housing 21 such that the fixing plate 40 pins the flange portion 30 formed on the outer peripheral surface of the barrel 23 against the housing 21. The fixing plate includes an open portion 40a, which corresponds to the outer peripheral shape of the barrel 23 and whose diameter is smaller than the diameter of the flange portion 30 that is disposed on the barrel 23, and plural fixing holes 40b into which screws 41 are inserted.

Further, although the planar shape of the fixing plate is not particularly limited, the fixing plate can have a vertically long elliptical or rectangular planar shape and can have a configuration where the open portion is disposed in the center portion of the fixing plate and where the fixing holes are disposed in both end portions of the fixing plate. Thus, even when a plurality of the plungers 25 are arranged in parallel, the distance between adjacent plungers can be shortened and space can be economized.

It will be noted that this fixing plate is a newly added member that is not present in conventional pumps, but the fixing plate does not require a complex design and can be easily manufactured by press molding using a press material, for example, and production costs also do not rise.

### (5) Plunger, Spring and Spring Seat

The plunger 25 shown in FIG. 2 is a rod-like member that has an outer shape that conforms to the small diameter space 23c in the barrel 23. Additionally, the plunger 25 is disposed with a collar portion 25a on its end portion on the opposite side of the fuel pressurization chamber 33 side; a spring seat 43 is locked to the collar portion 25a, and the spring 27 is nipped by and held between the spring seat 43 and the lower end of the barrel 23, whereby the plunger 25 is energized downward (in the opposite direction of the direction in which the plunger 25 pressurizes the fuel). Further, the cassette type pump used in the present invention has a configuration disposed with one of the plunger 25, and one of the spring 27 and one of the spring seat 43 are disposed in correspondence thereto. Moreover, just one of the discharge valve 29 is disposed in correspondence to the plunger 25.

Here, the fuel injection system of the present invention is characterized in that it uses just one cassette type pump that is disposed with just one plunger and just one discharge valve. Thus, the pump can be made compact, and the entire internal combustion engine to which just one of that pump is attached can be made compact.

Further, even when just one plunger and just one discharge valve are disposed, as mentioned later, pressure-feeding from the pump and injection of the internal combustion engine can be synchronized by making the gear ratio between the crankshaft and the camshaft and the number of cam crests of the cam that causes the plunger to reciprocally move into a predetermined combination. Consequently, fuel can be injected without causing variations in the injection pressure of the fuel. Additionally, because the aforementioned synchronous injection becomes possible regardless of the number of cylinders of the internal combustion engine, it becomes unnecessary to prepare plural types of pumps in response to the number of cylinders of the internal combustion engine, and the cassette type pump that is used can be made versatile. Further, because the pump can be made versatile, the pump and the parts used in the internal combustion engine can be made common, so production costs and maintenance costs can be lowered, and the fuel injection system can be made into a fuel injection system that has excellent maintainability such as service, replacement and detachment.

It will be noted that the fuel injection system of the present embodiment regulates the pressure of the fuel with a pressure regulator, so in contrast to a conventional cassette type pump, a lead is not disposed in the plunger. Consequently, fuel is not returned to the low pressure side via a lead from the fuel pressurization chamber, so wear and damage to the plunger, the barrel and the housing resulting from high pressure fuel can be eliminated. Further, because it is not necessary to dispose a lead in the plunger, it is not necessary for the pump to be disposed with a rack mechanism for controlling the rotational position of the plunger, and it is not necessary for the system overall to be disposed with a governor mechanism that actuates the rack mechanism. Consequently, the mechanical configuration of the cassette type pump or the system overall can be simplified, and mechanical strength and durability can be improved.

### (6) Tappet

A tappet 45 shown in FIG. 2 is interposed between the cam 19 that is disposed in the internal combustion engine and the plunger 25 or the spring seat 43 that is disposed in the cassette type pump 20, and the tappet 45 is a part for pushing up the plunger 25 in accompaniment with the up-and-down movement of the cam 19. The tappet 45 has an outer peripheral shape that conforms to the inner peripheral surface of the circular column space 21a in the housing 21 of the pump 20 and also has the function of centering the plunger 25 and the small diameter space 23c in the barrel 23. Further, the tappet 45 can also have a configuration that includes a tappet roller 47 in order to reduce wear resulting from contact with the cam 19.

In the fuel injection system of the present invention, the tappet can be connected to the plunger or the spring seat of the pump or can be disposed in the internal combustion engine. The fuel injection system may also have a configuration that does not use a tappet at all.

### 3. Common Rail (Pressure Accumulator)

As shown in FIG. 1, the common rail 11 is a part for accumulating high pressure fuel that is pressure-fed from the cassette type pump 20 and supplying fuel at an even pressure with respect to the plural injectors 15. A publicly known common rail can be appropriately used for this common rail.

Further, a pressure sensor 12 is attached to part of the common rail 11 and configured such that the common rail pressure can be detected by control means (ECU) 14 that controls a later-described pressure regulator 13.

Because of this common rail, high pressure fuel can be accumulated and the high pressure fuel can always be supplied with respect to the injectors, so it suffices for the cassette type pump to be given just the function of pressure-feeding fuel, and the configuration of the pump can be remarkably simplified. Further, noise during operation of the internal combustion engine can be reduced because higher pressure fuel can be injected.

### 4. Pressure Regulator and Pressure Control Means

The pressure regulator 13 is configured using a publicly known electromagnetic valve (pressure control valve), for example, and the opening of the valve body is set on the basis of a signal that is sent from the control means (ECU) 14 in response to the pressure value detected by the aforementioned pressure sensor 12 that is disposed in the common rail 11. Additionally, some of the fuel that has been pressure-fed from the cassette type pump 20 is appropriately discharged, whereby the pressure inside the common rail is controlled to a desired value.

That is, the fuel injection system of the present invention is a system where the cassette type pump continues to pressure-feed high pressure fuel without performing control of the flow rate, the injection timing and the pressure, the pressure regulator regulates the pressure inside the rail to a desired pressure value, the fuel injection system supplies the high pressure fuel to the injectors, and the injectors gauge the injection amount and the injection timing and inject, in order to supply, the fuel to the insides of the cylinders of the internal combustion engine.

By disposing this pressure regulator, it becomes unnecessary for the cassette type pump to control the pressure of the high pressure fuel that is pressure-fed and the fuel flow rate, and it suffices for the pump to simply continue pressure-feeding fuel that has been pressurized to a high pressure. Consequently, in comparison to a conventional common rail system, complex electronic control with respect to the pump can be omitted, regulation of the amount of fuel that is pressure-fed from the pump becomes possible by just the design of the cam and the plunger, and the configuration of the pump can be remarkably simplified.

Further, because the amount of fuel that is discharged from the pump can be controlled by changing the rotational speed of the cam and the design of the cam crest, the cassette type pump itself can be made versatile regardless of the specification of the internal combustion engine, and economical design and production become possible.

Moreover, because the fuel pressure can be freely controlled, start-up performance when it is cold and the stability of the operating state can be improved.

In relation to the position where this pressure regulator is attached, it is not particularly limited as long as it is between the discharge valve of the pump and the fuel injectors; for example, the pressure regulator can be attached to a position on an end portion of the common rail. By attaching the pressure regulator to the body of the common rail, the common rail pressure can be directly changed.

It will be noted that excess fuel that is to be discharged is refluxed to the fuel tank via a fuel reflux passage.

### 5. Fuel Injectors (Injectors) and Control Means

The fuel injectors 15 are connected to the common rail 11 and are parts for injecting high pressure fuel that is pressure-fed from the common rail 11 and supplying fuel to the insides of the cylinders of the internal combustion engine. The configuration of the injectors 15 is not particularly limited; for example, each of the injectors can have a configuration disposed with a nozzle body that includes a seat surface on which a needle valve body sits and an injection hole formed in the seat surface further downstream than the part of the seat surface that contacts the valve body, with the injector guiding, to the injection hole, fuel supplied from the upstream side of the seat surface when the needle valve body is lifted.

It will be noted that, although it is not illustrated, pressure amplifying means may also be disposed such that the common rail is not made excessively large and such that a mechanical piston can be effectively pushed by fuel having the common rail pressure at an arbitrary period.

The aforementioned injectors 15 can be electromagnetic valve type injectors that always energize the needle valve bodies toward the seat surfaces by springs or the like and open and close the needle valve bodies by switching between supplying electricity to and not supplying electricity to solenoids. In this case, the injection amount and the injection timing can be easily controlled by the control means (ECU) 14 for controlling the timing of the supply of electricity to the electromagnetic valves and the amount of time of the supply of electricity. More specifically, the fuel injection timing of the injectors of the internal combustion engine can be arbitrarily corresponded by control of the ECU, a cam sensor, and the injectors. Consequently, noise during engine operation and particulate matter and NOₓ (nitrogen oxide) included in exhaust gas can be reduced.

### 6. Operation of Fuel Injection System

### (1) Basic Operation

The flow of fuel in the fuel injection system of the present embodiment that has been described above will be described below with reference to FIG. 1 and FIG. 2.

First, fuel inside a fuel tank 17 is pumped up by a supply pump 51 via a prefilter (not shown) that traps foreign matter, and the fuel is pressure-fed to the pressure introduction chamber 31 of the cassette type pump 20 via a main filter 53. The fuel that has been pressure-fed into the pressure introduction chamber 31 is sent to the inside of the fuel pressurization chamber 33 via the fuel passage 37 that is disposed in the barrel 23 of the pump 20. Then, the plunger 25 is pushed up in accompaniment with rotation of the cam 19 that is disposed in the internal combustion engine, whereby the fuel passage 37 in the barrel 23 facing the fuel pressurization chamber 33 is closed, the fuel inside the fuel pressurization chamber 33 is pressurized to a high pressure, and the high pressure fuel is pressure-fed to the common rail 11 via the discharge valve 29. The high pressure fuel that has been pressure-fed is accumulated inside the common rail 11 and is supplied at an even pressure with respect to the respective injectors 15 in a state where the pressure of the fuel has been regulated by the pressure regulating valve 13. In this state, the injection holes in the injectors 15 are opened, whereby the high pressure fuel can be injected, so the high pressure fuel can be supplied to the insides of the cylinders of the internal combustion engine at a desired timing.

That is, in the cassette type pump, the work of pressurizing the fuel to a high pressure and discharging the high pressure fuel to the common rail is repeated, so the pressure inside the common rail can always be held in a high pressure state. Further, the common rail pressure that is held in a high pressure state can be relatively easily controlled to a desired pressure value using the pressure regulator and supplied to the injectors. Moreover, by controlling the injecting timing and the amount of injection time of the injectors, high-pressure and multiple-stage injection that could not be obtained in the conventional cassette type pump can be realized.

Further, because the configuration of the pump is simplified, excellent durability with respect to the pressure of high pressure fuel can be exhibited and fuel can be stably injected.

### (2) Synchronous Injection

Further, even with the fuel injection system of the present invention, which is disposed with one cassette type pump that is disposed with one plunger and one discharge valve, the timing of pressure-feeding from the pump and the injection timing of the injectors can be synchronized by making the number of cam crests of the cam that causes the plunger to reciprocally move and the gear ratio between the camshaft and the crankshaft into a predetermined combination.

That is, although the fuel that is supplied to the respective injectors can always be maintained at a high pressure by the common rail, the pressure inside the common rail always changes in response to the pressure-feeding of the high pressure fuel from the pump. Consequently, depending on the relationship between the period of pressure-feeding of the pump and the period of injection from the injectors, there is the potential for variations to arise in the pressure of the fuel that is injected from the respective injectors. For that reason, performing the aforementioned synchronous injection is important, and uniform injection becomes possible.

For example, in a case where the number of cylinders of the internal combustion engine is three and the internal combustion engine rotates two times in one cycle of the internal combustion engine, then by making the number of cam crests three and employing a combination where the gear ratio between the camshaft and crankshaft is 1/2, pressure-feeding of three times, which is the same as the number of cylinders of the internal combustion engine, becomes possible in one cycle from the pump. Further, in the same internal combustion engine, by making the number of cam crests two and employing a combination where the gear ratio between the camshaft and the crankshaft is 3/4, then similar to what has been described above, pressure-feeding of three times, which is the same as the number of cylinders of the internal combustion engine, becomes possible in one cycle from the pump.

In this manner, in one cycle of the internal combustion engine, by making the number of times that the high pressure fuel is pressure-fed from the pump to match the number of cylinders of the internal combustion engine, the timing of pressure-feeding of the high pressure fuel from the pump and the timing of injection of the fuel from the injectors can be synchronized. Consequently, as shown in FIG. 3, whether the period of injection from the injectors is a timing A or a timing B, for example, whichever period is selected, the common rail pressure at the time of injection of the respective injectors can be made into a substantially equal state, so fuel injection in a uniform pressure can be performed with respect to the insides of the respective cylinders.

Further, in a case where the number of cylinders of the internal combustion engine is four and the internal combustion engine rotates two times in one cycle of the internal combustion engine, then by making the number of cam crests two and employing a combination where the gear ratio between the camshaft and the crankshaft is 1, pressure-feeding of four times, which is the same as the number of cylinders of the internal combustion engine, becomes possible in one cycle from the pump. Moreover, in the same internal combustion engine, by making the number of cam crests three and employing a combination where the gear ratio between the camshaft and the crankshaft is 2/3, then similar to what has been described above, pressure-feeding of four times, which is the same as the number of cylinders of the internal combustion engine, becomes possible in one cycle from the pump.

In this case also, as shown in FIG. 4, whether the period of injection from the injectors is a timing A or a timing B, for example, whichever period is selected, the common rail pressure at the time of injection of the respective injectors can be made into a substantially equal state, so fuel injection in a uniform pressure can be performed with respect to the insides of the respective cylinders.

In this manner, by synchronizing the period of pressure-feeding from the pump and the period of injection of the fuel from the injectors, the operating state of the internal combustion engine stabilizes, and noise during operation can be reduced. Further, the amount of particulate matter and NOₓ included in the exhaust gas can be reduced, and the exhaust gas can be purified.

Consequently, as mentioned above, the pump can be made versatile regardless of the number of cylinders of the internal combustion engine, production costs and maintenance costs can be reduced, and the fuel injection system can be made into a fuel injection system that has excellent maintainability such as service, replacement and detachment.

1-5. (canceled)

6. An internal combustion engine fuel injection system, comprising:
an internal combustion engine disposed with a cam;
one cassette type pump detachably attached to the internal combustion engine, the one cassette type pump pressurizes fuel to a high pressure and pressure-feeds fuel in response to rotation of the cam; and
a common rail which accumulates high pressure fuel that is pressure-fed from the one cassette type pump and which supplies the high pressure fuel with respect to a plurality of fuel injectors,
wherein the cam is fixed to a camshaft and the camshaft is connected with a predetermined gear ratio to a crankshaft of the internal combustion engine, and
the one cassette type pump having a single plunger for pressurizing fuel in response to rotation of the cam, and a single discharge valve for discharging fuel that has been pressurized by the plunger.

7. The internal combustion engine fuel injection system of claim 6, wherein a number of times that the high pressure fuel is pressure-fed from the cassette type pump during one cycle of the internal combustion is made to match the number of cylinders of the internal combustion engine by a combination of selecting the gear ratio and the number of cam crests of the cam.

8. The internal combustion engine fuel injection system of claim 6, further comprising: a pressure regulator that regulates pressure inside the common rail; and
pressure control means for controlling the pressure regulator on the basis of a pressure value inside the common rail.

9. The internal combustion engine fuel injection system of claim 7, further comprising: a pressure regulator that regulates pressure inside the common rail; and
pressure control means for controlling the pressure regulator on the basis of a pressure value inside the common rail.

10. The internal combustion engine fuel injection system of claim 6, wherein the fuel injectors are electromagnetic control valves.

11. The internal combustion engine fuel injection system of claim 6, wherein the fuel injection system is used in any of construction machinery, agricultural machinery, marine vessels and electrical generators.
